(19) United States
(12) Patent Application Publication
(10) Pub. No.: US 2025/0227206 A1
(43) Pub. Date: Jul. 10, 2025

(54) VIDEO COMMUNICATION SYSTEM

(71) Applicant: Rachel Reeves, Houston, TX (US)

(72) Inventor: Rachel Reeves, Houston, TX (US)

(21) Appl. No.: 18/409,001

(22) Filed: Jan. 10, 2024

(51) Int. Cl. H04N 7/18; H04N 23/54; H04N 23/90

(52) U.S. Cl. CPC H04N 7/181; H04N 23/54; H04N 23/90

(57) ABSTRACT

A video communication system for facilitating a driver of a vehicle and a child positioned in a rear seat of the vehicle in viewing each other includes a driver module and a child module. The driver module records and transmits video of the driver to the child module for the child to view. The child module records and transmits video of the child to the driver module for the driver to view. The driver module is configured to mount to a dashboard of the vehicle, and the child module is configured to mount to a chair of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to video communication system and more particularly pertains to a new video communication system for facilitating a driver of a vehicle and a child positioned in a rear seat of the vehicle in viewing each other.

### (2) Description of Related Art Including Information Disclosed Under 37 CFR 1.97 and 1.98

Various video monitor systems are known to the prior art which may be mounted in a vehicle so that a driver may visually monitor a child situated in a car seat in the vehicle while driving. However, the prior art fails to describe such an apparatus which also has a camera oriented toward the driver's seat and a display screen for the child to view such that the child may see the driver. Such an apparatus would be beneficial, for example, to comfort infants and other children by presenting them with an image of the driver, who may typically a parent or other trusted adult. By making the image a video stream, the driver could also interact with the child. The child would be able to hear the driver speaking by nature of being within hearing range of the driver and may simultaneously view the driver via the display.

### BRIEF SUMMARY OF THE INVENTION

An embodiment of the disclosure meets the needs presented above by generally comprising a driver module and a child module which are in communication with each other. The driver module comprises a driver housing, a driver processor, a driver camera, and a driver display. The driver processor is mounted in the driver housing and is operatively coupled to the driver camera and the driver display. The driver camera and the driver display are positioned on a front side of the driver housing and face a same direction. a driver transceiver is mounted in the driver housing and is in operative communication with the driver processor. A dashboard mount is coupled to the driver housing and is configured to mount the driver housing to a dashboard of an automobile.

The child module comprises a child housing, a child processor, a child camera, and a child display. The child processor is mounted in the child housing and is operatively coupled to the child camera and the child display. The child camera and the child display face a shared direction away from the child housing. A child transceiver is mounted in the child housing and is in operative communication with the child processor. The child processor is operably coupled to the driver processor via the child transceiver and the driver transceiver. A chair mount is coupled to the child housing and is configured to mount the child housing to a chair of the automobile. The driver processor is programmed to selectively cause the child display to display a driver video stream captured by the driver camera and cause the driver display to display a child video stream captured by the child camera.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a kit view of a video communication system according to an embodiment of the disclosure.

FIG. 2 is a rear kit view of an embodiment of the disclosure.

FIG. 3 is an in-use view of an embodiment of the disclosure.

FIG. 4 is a breakaway view of a vehicle with an embodiment of the disclosure in use within the vehicle.

FIG. 5 is a block diagram of an embodiment of the disclosure.

### DETAILED DESCRIPTION OF THE INVENTION

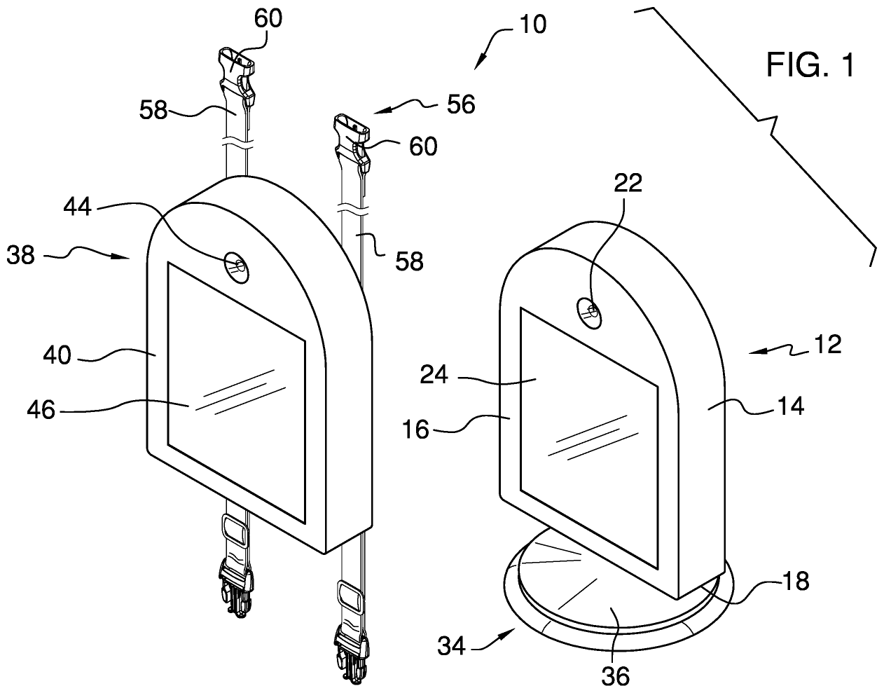

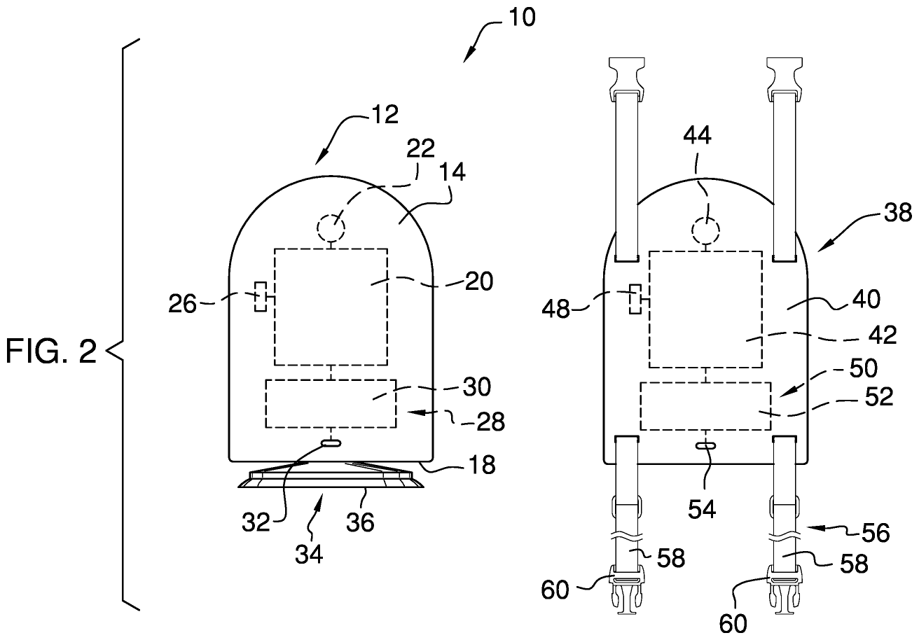

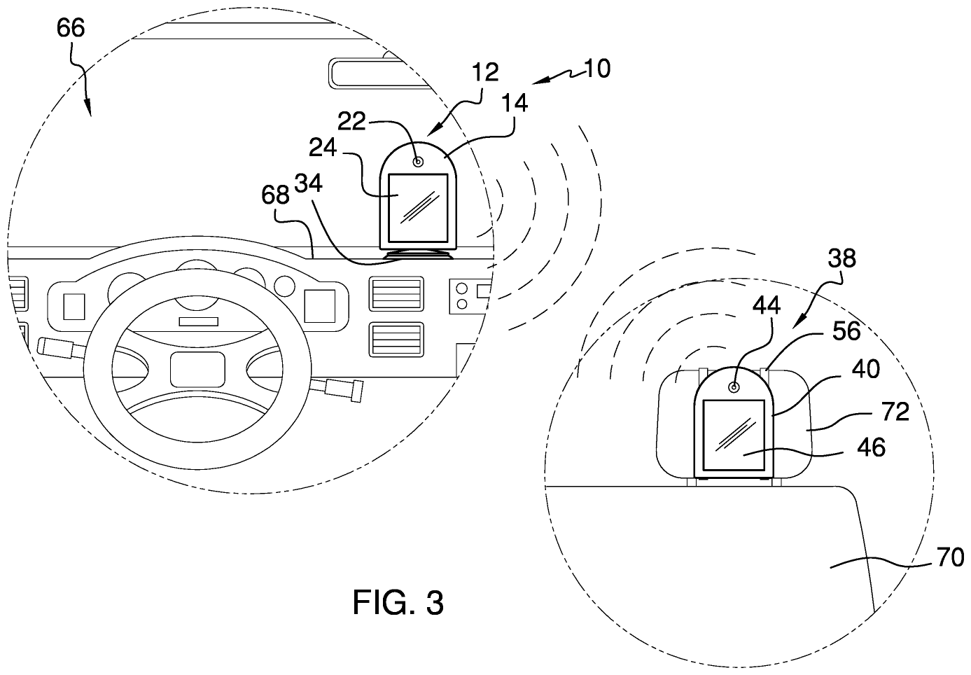

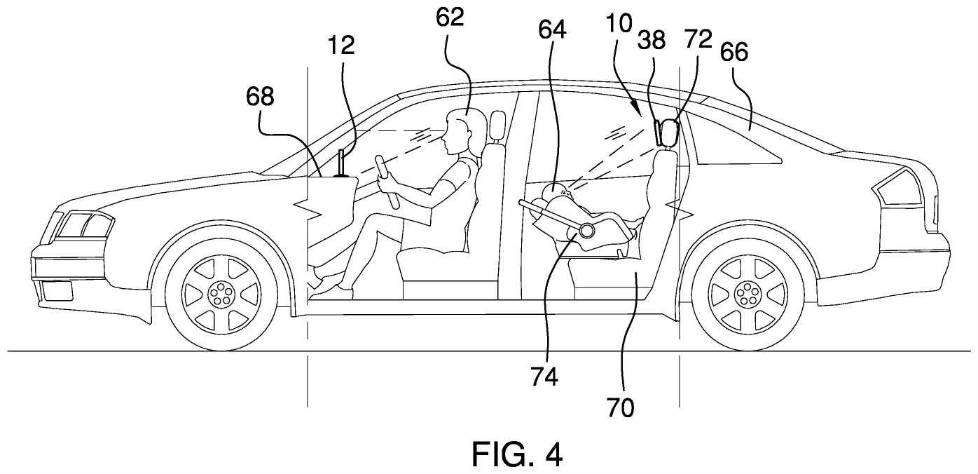

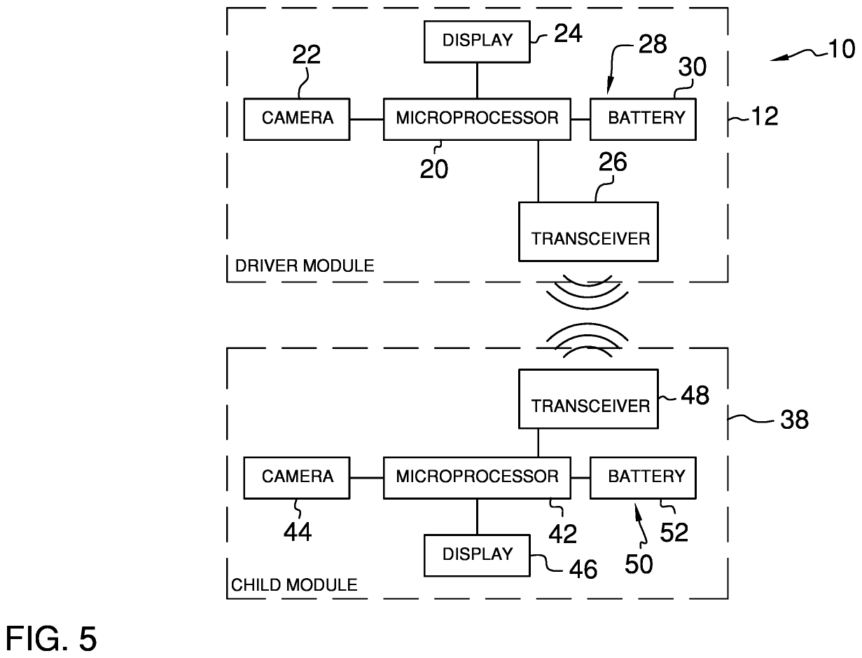

With reference now to the drawings, and in particular to FIGS. 1 through 5 thereof, a new video communication system embodying the principles and concepts of an embodiment of the disclosure and generally designated by the reference numeral 10 will be described.

As best illustrated in FIGS. 1 through 5, the video communication system 10 generally comprises a driver module 12 and a child module 38 which are operatively coupled to each other via wireless communication means. The driver module 12 includes a driver housing 18, a driver processor 20, a driver camera 22, and a driver display 24. The driver processor 20 is mounted in the driver housing 18 and is operatively coupled to the driver camera 22 and the driver display 24. The driver camera 22 is positioned on and faces away from a front side 14 of the driver housing 18. The driver display 24 is also positioned on the front side 14 of the driver housing 18 and faces a same direction as the driver camera 22.

A driver transceiver 26 is mounted in the driver housing 18 and is in operative communication with the driver processor 20. A driver power supply 28 is mounted in the driver housing 18 and is electrically coupled to the driver processor 20. The driver power supply 28 comprises a driver battery 30 but may comprise a capacitor or any other suitable power storage. A driver charge port 32 is mounted on the driver housing 18 and is electrically coupled to the driver power supply 28. A charging cord may couple to the driver charge port 32 and an external electrical power source to charge the driver power supply 28.

A dashboard mount 34 is coupled to the driver housing 18 and is configured to mount the driver housing 18 to a dashboard 68 of an automobile 66. The dashboard mount 34 comprises a suction cup 36 which is positioned on a bottom side 16 of the driver housing 18. Any suitable mount for attaching the dashboard mount 34 to the dashboard 68 may be used. For example, the dashboard mount 34 may include a weighted, frictionally enhanced support as is commonly used to support GPS devices, phones or the like. Or the dashboard mount 34 may have a magnet, a clip configured to clip onto an air vent louver, or the like.

The child module 38 comprises a child housing 40, a child processor 42, a child camera 44, and a child display 46. The child processor 42 is mounted in the child housing 40 and is operatively coupled to the child camera 44 and the child display 46. The child display 46 and the child camera 44 are mounted on the child housing 40 and face a shared direction. A child transceiver 48 is mounted in the child housing 40 and is in operative communication with the child processor 42. The child processor 42 is operably coupled to the driver processor 20 via the child transceiver 48 and the driver transceiver 26. In this manner, the child processor 42 may receive commands from the driver processor 20 which may also lead to resultant commands being transmitted to the child camera 44 and the child display 46.

A child power supply 50 is mounted in the child housing 40 and is electrically coupled to the child processor 42. The child power supply 50 comprises a child battery 52 but may comprise a capacitor or any other suitable power storage. A child charge port 54 is mounted on the child housing 40 and is electrically coupled to the child power supply 50. A charging cord may then couple to the child charge port 54 and an external electrical power source to charge the child power supply 50.

A chair mount 56 is coupled to the child housing 40 and is configured to mount the child housing 40 to a chair 70 of the automobile 66. The chair mount 56 comprises a pair of straps 58 which are laterally spaced from each other with respect to the child housing 40 and are adapted to extend around a headrest 72 of the chair 70. Each strap 58 is length-adjustable by a slider or other suitable means. Each strap 58 also comprises a buckle 60 for alternately coupling and uncoupling a pair of segments of the associated strap 58. In other embodiments, the chair mount 56 may comprise a hook, a hook-and-loop fastener, or other suitable mounting means to attach to the chair 70.

The driver processor 20 is programmed to selectively cause the child display 46 to display a driver video stream captured by the driver camera 22 and cause the driver display 24 to display a child video stream captured by the child camera 44. The driver processor 20 may be operated by a user interface such as a touchscreen input, a mobile phone, another remote electronic device, or the like. In the case of remote electronic devices, the driver transceiver 26 may wirelessly communicate with such devices to transmit control signals to the driver processor 20. The driver transceiver 26 may also communicate to an external wireless network to receive video and audio signals such as from a music streaming service, a television streaming service, or the like. Video and audio obtained via the external wireless network may be presented by the driver module 12 or the child module 38, and the selected module may include speakers for playing audio. The driver transceiver 26 and the child transceiver 48 may operate via any suitable wireless communication protocol including WiF® protocols, Blutooth® protocols, or the like.

In use, the driver processor 20 is operated, such as via the user interface as described. The driver processor 20 may be operated to simultaneously present the child video stream on the driver display 24 and present the driver video stream on the child display 46. Such operation allows for a driver 62 of the automobile 66 to visually monitor a child 64 placed in a car seat 74 in view of the child camera 44 and for the child 64 to view the driver 62. Viewing the driver 62, especially if the driver 62 is a parent or other individual the child 64 trusts, may provide the child 64 with increased feelings of security. The child module 38 may be mounted to the headrest of a chair in which the car seat 74 is placed in a rear-facing manner. The child module 38 may also be mounted to the headrest of a chair which is positioned forwardly of the chair in which the car seat 74 is placed if the car seat 74 is positioned in a forward-facing manner. In some embodiments, the driver processor 20 may be controlled to cause the child display 46 to present a video from a video streaming service or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A video communication system for visually communicating with a child in a car seat within an automobile from a driver seat of the automobile, the system comprising:
a driver module comprising:
a driver housing;
a driver processor mounted in the driver housing;
a driver camera mounted on the driver housing and in operative communication with the driver processor, the driver camera being positioned on and facing away from a front side of the driver housing;
a driver display mounted on the driver housing and in operative communication with the driver processor;
a driver transceiver mounted in the driver housing and in operative communication with the driver processor; and
a dashboard mount coupled to the driver housing, the dashboard mount being configured to mount the driver housing to a dashboard of the automobile; and
a child module in operative communication with the driver module, the child module comprising:
a child housing;
a child processor mounted in the child housing;
a child camera mounted on the child housing and in operative communication with the child processor, the child camera being positioned on and facing away from a front side of the child housing;
a child display mounted on the child housing and in operative communication with the child processor;
a child transceiver mounted in the child housing and in operative communication with the child processor, the child processor being operably coupled to the driver processor via the child transceiver and the driver transceiver; and
a chair mount coupled to the child housing, the chair mount being configured to mount the child housing to a chair of the automobile;
wherein the driver processor is programmed to selectively cause the child display to display a driver video stream captured by the driver camera and cause the driver display to display a child video stream captured by the child camera.

2. The system of claim 1, wherein the driver display and the driver camera face a same direction.

3. The system of claim 1, wherein the dashboard mount comprises a suction cup, the suction cup being positioned on a bottom side of the driver housing.

4. The system of claim 1, wherein the driver module further comprises a driver power supply mounted in the driver housing and electrically coupled to the driver processor.

5. The system of claim 4, wherein the driver power supply comprises a driver battery.

6. The system of claim 4, wherein the driver module further comprises a driver charge port mounted on the driver housing and electrically coupled to the driver power supply.

7. The system of claim 1, wherein the child display and the child camera face a shared direction.

8. The system of claim 1, wherein the chair mount comprises a strap which is configured to be positionable around a headrest of the chair.

9. The system of claim 8, wherein the strap is length-adjustable.

10. The system of claim 8, wherein the strap comprises a buckle for alternately coupling and uncoupling a pair of segments of the strap.

11. The system of claim 1, wherein the chair mount comprises a pair of straps configured to be positionable around a headrest of the chair, the pair of straps being laterally spaced from each other with respect to the housing.

12. The system of claim 11, wherein each strap of the pair of straps is length-adjustable.

13. The system of claim 11, wherein each strap of the pair of straps comprises a buckle for alternately coupling and uncoupling a pair of segments of the strap.

14. The system of claim 1, wherein the child module further comprises a child power supply mounted in the child housing and electrically coupled to the child processor.

15. The system of claim 14, wherein the child power supply comprises a child battery.

16. The system of claim 14, wherein the child module further comprises a child charge port mounted on the child housing and electrically coupled to the child power supply.

17. A video communication system for visually communicating with a child in a car seat within an automobile from a driver seat of the automobile, the system comprising:
a driver module comprising:
a driver housing;
a driver processor mounted in the driver housing;
a driver camera mounted on the driver housing and in operative communication with the driver processor, the driver camera being positioned on and facing away from a front side of the driver housing;
a driver display mounted on the driver housing and in operative communication with the driver processor, the driver display and the driver camera facing a same direction;
a driver transceiver mounted in the driver housing and in operative communication with the driver processor;
a dashboard mount coupled to the driver housing, the dashboard mount being configured to mount the driver housing to a dashboard of the automobile, the dashboard mount comprising a suction cup, the suction cup being positioned on a bottom side of the driver housing;
a driver power supply mounted in the driver housing and electrically coupled to the driver processor, the driver power supply comprising a driver battery; and
a driver charge port mounted on the driver housing and electrically coupled to the driver power supply; and
a child module comprising:
a child housing;
a child processor mounted in the child housing;
a child camera mounted on the child housing and in operative communication with the child processor, the child camera being positioned on and facing away from a front side of the child housing;
a child display mounted on the child housing and in operative communication with the child processor, the child display and the child camera facing a shared direction;
a child transceiver mounted in the child housing and in operative communication with the child processor, the child processor being operably coupled to the driver processor via the child transceiver and the driver transceiver;
a chair mount coupled to the child housing, the chair mount being configured to mount the child housing to a chair of the automobile, the chair mount comprising a pair of straps, each strap of the pair of straps being length-adjustable, each strap of the pair of straps comprising a buckle for alternately coupling and uncoupling a pair of segments of the strap, each strap of the pair of straps being configured to be positionable around a headrest of the chair, the pair of straps being laterally spaced from each other with respect to the child housing;
a child power supply mounted in the child housing and electrically coupled to the child processor, the child power supply comprising a child battery; and
a child charge port mounted on the child housing and electrically coupled to the child power supply;
wherein the driver processor is programmed to selectively cause the child display to display a driver video stream captured by the driver camera and cause the driver display to display a child video stream captured by the child camera.
